(19) United States
(12) Patent Application Publication
(10) Pub. No.: US 2005/0169326 A1
(43) Pub. Date: Aug. 4, 2005

(54) Laser architectures for coherent short-wavelength light generation

(76) Inventors: James Jeffrey Jacob, Aptos, CA (US); Andrew John Merriam, San Francisco, CA (US)

Correspondence Address: ANDREW MERRIAM, 2521 S RODEO GULCH ROAD, SOQUEL, CA, 95073, US

(21) Appl. No.: 11/045,737

(22) Filed: Jan. 28, 2005

Related U.S. Application Data
(60) Provisional application No. 60/540,860, filed on Jan. 30, 2004.

(51) Int. Cl. H01S 3/10

(52) U.S. Cl. 372/22; 372/21; 372/6

(57) ABSTRACT

Several methods are disclosed for the generation of coherent short-wavelength electromagnetic radiation through optical nonlinear frequency mixing means. The invention involves several stages of efficient nonlinear frequency conversion to shift the output of high-power infra-red fiber-lasers into the vacuum ultraviolet (VUV). The described laser source architecture is designed around non-critically phase-matched (NCPM) sum-frequency mixing (SFM) interactions in the nonlinear crystal CLBO. The NCPM interaction is an optimum condition for bulk frequency conversion of cw radiation because it allows tight focusing of the input laser radiation without Poynting vector walk-off, thereby increasing the non-linear drive significantly. The sub-200-nm output wave is generated from SFM of a long-wave IR laser field and a short-wave UV laser field. The long-wave laser beam may be derived directly from a rare-earth-doped fiber laser, whereas the short-wavelength UV beam is provided as the fourth frequency harmonic of a second rare-earth-doped fiber laser system.

### CROSS-REFERENCE TO RELATED APPLICATION

This application claims the benefit of U.S. Provisional Patent Application Ser. No. 60/540,860, “Laser architectures for coherent short-wavelength light generation” by J. J. Jacob and A. J. Merriam, filed Jan. 30, 2004, which is incorporated herein by reference.

### BACKGROUND OF THE INVENTION

High average power, diffraction-limited, continuous-wave (cw) lasers that generate vacuum-ultraviolet (VUV) light (with wavelength less than 200 nm) are useful in a number of advanced semiconductor photolithography applications, including maskless lithography, direct writing of reticles, and defect inspection of reticles and patterned wafers.

The difficulty of generating optical radiation increases as the desired wavelength decreases, or equivalently, as the desired photon energy increases. Traditionally, discharge lamps, where an electrical current is passed through a gas containing different constituent species, have been used in many applications where short-wavelengths have been required. While these lamps have been acceptable for certain microscopic imaging and spectroscopic applications, the negligible optical coherence, broad spectral width and low brightness preclude the use of such lamps for more advanced applications. There exist today many sources of laser radiation produced in a variety of media: gasses, liquids, and solids. The traditional workhorse of the photolithography industry has been the excimer laser. This type of electrical discharge laser system has excellent electrical efficiency and provides copious amounts of light, but for a number of reasons, including poor beam quality, broad excitation linewidths, and safety issues, excimer laser systems are unsuitable for most precision applications. Frequency-doubled ion lasers operating near 250 nm are used extensively for semiconductor inspection applications, but they exhibit poor efficiency, have large footprints, require water-cooling and do not generate light below 200 nm.

To enhance system durability, wallplug efficiency, and generated optical power levels, it is strongly desired to provide an all-solid-state source of VUV light. A class of useful and commercially proven solid-state lasers has been provided by rare-earth-ions doped into bulk crystal or glass hosts. These devices may be optically pumped by diodes or flashlamps and are capable of generating high cw and pulsed powers, but their region of operation is generally limited to the infrared (IR) region of the spectrum. A common example is the neodymium-doped yttrium-aluminum-garnet (Nd:YAG) laser system operating at 1064 nm. The field of nonlinear optics has developed in order to convert the fixed frequencies of powerful solid-state lasers such as Nd:YAG to other regions of the spectrum where it may be of use in a multitude of applications. A variety of nonlinear optical techniques now provide broad coverage of the IR and UV. For example, the second frequency harmonic of the Nd:YAG laser system at 532 nm (green light) may be provided by applying the fundamental laser output to an appropriately-cut potassium titanyl phosphate (KTP) crystal. This green light may subsequently be frequency doubled to 266-nm (UV light) by applying the green light to a beta-barium-borate (BBO) crystal. Thus, three different optical wavelengths may be generated by a single laser system. In addition to the second-harmonic generation (SHG) examples mentioned, other interactions including sum-frequency mixing (SFM) are possible, wherein two non-degenerate frequencies interact in a nonlinear crystal to produce an output whose frequency is the sum of the interaction frequencies. For example, the third frequency harmonic of the Nd:YAG laser system at 354.7 nm may be provided by applying the fundamental (1064 nm) and second-harmonic (532 nm) waves in a lithium triborate (LBO) crystal. In this fashion, a variety of UV laser sources have been demonstrated that are based on nonlinear frequency conversion of Q-switched, diode-pumped solid-state laser systems. Generally speaking, the spatial and temporal characteristics of the driving laser field(s) in a nonlinear interaction are replicated onto the generated light field. High-quality interacting beams are therefore essential to produce high-quality output beams. Thermal lensing effects in bulk lasing media operated at high powers cause degradation of fundamental beam quality; high beam quality in the UV has therefore been difficult to achieve using Q-switched bulk laser sources.

All solid-state nonlinear frequency conversion is limited by the optical characteristics of the chosen nonlinear crystal. The three most important parameters of a nonlinear crystal are the magnitude of its nonlinearity, its birefringence, and its absorption profile. The non-linear optical crystal that generates nonlinear radiation must have high transparency over the entire range of input and output wavelengths and have phase-matching properties that enable a three-wave SFM interaction, using available wavelengths. Because the solid-state non-linear susceptibilities responsible for nonlinear frequency generation are quite small at optical frequencies, interacting electromagnetic waves must be phase-matched across many coherence lengths of nonlinear material to attain appreciable conversion efficiency. Nonlinear frequency generation conversion efficiencies also generally scale with the intensity of the interacting beams, so that more intense electromagnetic waves are beneficial for increased conversion. The birefringence phase-matching limitations of available crystals impose a strict condition on the wavelengths that may be mixed. Frequency conversion at shorter wavelengths has traditionally been more difficult and less efficient due to the properties of the nonlinear optical materials used for UV generation. Many nonlinear crystals are transparent in the visible region of the spectrum but become opaque in the UV. Although further crystal development is underway, at present only two of the borates—beta-barium borate (BBO) and cesium-lithium borate (CLBO)—have the requisite combination of transparency, birefringence, and commercial viability to be appropriate for VUV generation. These crystals may be procured in a variety of sizes and crystal orientations from vendors such as Cleveland Crystal (Cleveland, Ohio), Oxide (Japan), Photop (Shanghai, PRC), and Coherent (Santa Clara, Calif.).

Recently, a great deal of development work has been carried out in the field of fiber lasers. These lasers incorporate the active lasing dopant ions into a thin, flexible, glass matrix, and the output light may easily be directed by low-loss fiber propagation. These “all-fiber” lasers are attractive because there are minimal alignment issues, and the output beam quality is predominantly determined by physical fiber structure. Rare-earth-doped fiber laser systems now provide diffraction-limited beam quality at ever-increasing average power levels, with output wavelengths between 900-nm and 1200-nm, excellent wall-plug efficiency and scalability, inherently rugged design, and compact geometry. One example is the ytterbium-doped fiber laser that is pumped by fiber-coupled laser diodes at 976 nm and can generate 100's of Watts near 1080 nm. Both fiber components and turn-key laser systems are available in a variety of ouptut powers and bandwidths from manufacturers such as Nufern (East Granby, Conn.). It is strongly desirable to provide an all-solid-state VUV source that retains the advantageous beam qualities of the fiber laser outputs, but this generally requires several stages of efficient nonlinear frequency conversion from low-peak-power sources.

Efficient nonlinear interactions using low-peak-power sources have traditionally been difficult to achieve. In general, the nonlinear ‘drive’ available for frequency conversion scales with the intensity of the interacting beams, so that short-wavelength cw sources have traditionally provided reduced optical output powers compared to, for example, Q-switched pulsed sources. The usual method for increasing the interacting intensities has been to focus the beams to ever-smaller spot sizes in the nonlinear medium. This method is limited, however, both by fundamental constraints on optical waves (diffraction), by thermal lensing issues, and by Poynting-vector walk-off in the nonlinear medium.

To avoid the walk-off phenomenon, it is highly advantageous to operate a birefringent nonlinear optical crystal at the so-called ‘non-critical’ phase-matching (NCPM) condition, i.e., where both input optical waves propagate at 90 degrees to the crystal optic axis. Tightly-focused beams may then be employed for highly-efficient frequency mixing operations, a situation that is clearly beneficial for low-peak-power optical beams such as the output from cw fiber laser systems. For reasons known in the art, including reduced nonlinearity and efficiency, critically-phase-matched interactions are less attractive for frequency conversion. Although the general benefits of NCPM interactions are well known, the birefringence of different nonlinear optical crystals restrict the types of NCPM interactions each crystal can provide. This makes some crystals more attractive than others for a given application, ceteris paribus. In the VUV frequency range of interest, only CLBO can be non-critically phase-matched. To avoid hygroscopic degradation and maximize lifetimes, this crystal is preferably operated at an elevated temperature. The crystal's indices of refraction depend upon the crystal temperature, and therefore the phase-matching conditions, that determine the allowed set of interacting wavelengths, are also a function of temperature. A NCPM SFM interaction is achieved by appropriately applying pairs of allowed wavelengths at a given nonlinear crystal temperature. Often, for a given set of input wavelengths and powers, the nonlinear conversion process is optimized by ‘temperature-tuning’ the crystal.

A second means by which the intensities of low-peak-power sources may be increased is by enclosing the nonlinear crystal within a resonant optical cavity. Resonant cavity enhancement, whereby the circulating intensity may be raised by factors of 100 or more, is an effective means to raise nonlinear drive strengths using cw beams. To this end, researchers have inserted nonlinear media both inside laser oscillators (intracavity frequency conversion, where the enhancement of the circulating wave is essentially free), and external to the laser cavity (where it is called a buildup cavity). Because intracavity conversion is not generally possible with fiber lasers, in the present invention the buildup cavity length must be phase-locked to the interacting beam(s) to maintain cavity resonance. Although there are several techniques for cavity locking based on nulled lock-in detection known in the art, the best choice depends upon the spectral attributes of the driving lasers and the desired Q-factor of the cavity. The length of a singly-resonant cavity may be forced to follow the frequency variations of a single drive laser with no constraints on the drive laser's output. In the case of a doubly-resonant cavity, where the cavity is expected to maintain resonance with two interacting electromagnetic waves, the wavelength of at least one of the driving lasers must be controlled.

For these and other reasons, prior-art ultraviolet laser systems suffer from low power level, short lifetime, and low efficiency. Moreover, none of the prior-art laser systems provide a high-quality output beam with vacuum-ultraviolet (VUV) wavelengths.

### SUMMARY OF THE INVENTION

The present invention describes architectures for the efficient generation of coherent laser radiation in the sub-200-nm vacuum ultraviolet (VUV) wavelength region. The generation of high average VUV power levels is now tractable given recent developments in fiber laser sources, non-linear optical materials, and optical cavity enhancement techniques. The invention involves several stages of efficient nonlinear frequency conversion to shift the output of high-power infra-red fiber-lasers into the vacuum ultraviolet (VUV). Nonlinear frequency conversion can maintain the high beam quality of the fiber laser systems to provide the important combination of high power, high beam quality, and short wavelength. The capabilities of the birefringent nonlinear optical crystals used for this purpose, in conjunction with the wavelengths and spectral characteristics of rare-earth-doped fiber lasers, define the overall architecture of the laser system. VUV light is generated by nonlinear sum-frequency mixing using the birefringent crystal CLBO. Furthermore, in order to maximize the efficiency of the frequency mixing, the interaction wavelengths are chosen to satisfy non-critical phase-matching (NCPM) in the CLBO nonlinear optical crystal. Commercial suppliers of the CLBO crystal recommend operating the crystal at temperatures near 150 degrees centigrade in order to reduce water absorption and extend crystal longevity. Due to the crystal's temperature-dependent birefringence and refractive indices, the crystal operating temperature influences the sets of wavelengths that may be used for various nonlinear SFM interactions. In general, to generate VUV wavelengths, CLBO birefringence limitations require the interaction of a long-wavelength (IR) beam in the vicinity of 1100 nm and a short-wave (UV) beam in the vicinity of 240 nm. The long-wave laser beam may be derived directly from a rare-earth-doped fiber laser, whereas the short-wavelength UV beam is provided as the fourth frequency harmonic of a second rare-earth-doped fiber laser system. The fourth-frequency-harmonic generation is provided by two stages of second-harmonic generation (SHG) in birefringent nonlinear crystalline media.

In some embodiments, the two SHG modules include resonant optical cavities to increase the circulating intensities of the interacting laser fields. In other embodiments, the SHG modules include periodically-poled nonlinear crystals.

In some embodiments, the generated radiation is continuous-wave (cw). In other embodiments, an amplitude modulator may be disposed within the fiber laser systems to provide a pulsed optical source with variable pulselength and duty cycle.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates a schematic embodiment of a laser device according to the present invention.

FIG. 2 is a graph that shows values of interacting wavelengths that provide for non-critical phase-matching sum-frequency-mixing interactions in CLBO at two temperatures (20 degrees and 150 degrees centigrade). The sub-200-nm wavelength of the generated light is the graph ordinate.

FIG. 3 illustrates one preferred embodiment of a 193.4 nm laser source based on efficient frequency mixing of fiber lasers according to the present invention.

### DETAILED DESCRIPTION OF THE INVENTION

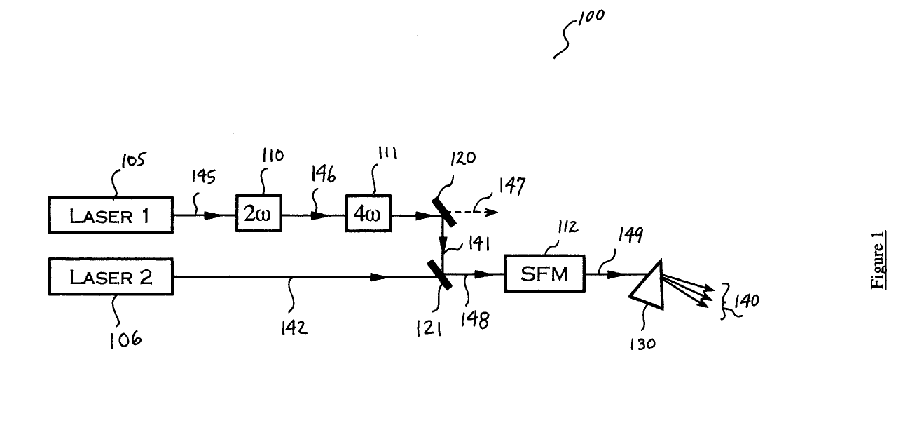

FIG. 1 is a schematic diagram of a laser architecture 100 according to the present invention. In summary, the frequency harmonics of two fiber laser systems 105, 106 are mixed in a sum-frequency module 112 to produce sub-200-nm coherent laser light. Fundamental beams 145 and 142 may be pulsed or cw, resulting in a pulsed or cw VUV output beam 149. To generate VUV wavelengths, the limited birefringence of CLBO can support only a type-1 phase matching interaction between a long-wave (infra-red) electromagnetic (EM) field with a short-wave (ultraviolet) EM field. This means, in general, that one of the two driving IR fiber lasers must be frequency-quadrupled to the ultraviolet via two successive stages of frequency doubling. Accordingly, fundamental output 145 of laser 105 is first frequency doubled in a first second-harmonic generation (SHG) module 110 to a visible wavelength in the region of 470 nm. The second harmonic light 146 is subsequently frequency doubled in a second SHG module 111 to an ultraviolet wavelength in the region of 238 nm. The second- and fourth-harmonic modules 110, 111 consist of an appropriate nonlinear crystal, that in some embodiments is atmosphere- or temperature-controlled, and that in some embodiments is contained within a resonant optical cavity to increase the circulating intensity of the lower-frequency light. In order to separate the frequency harmonics, dichroic mirror 120 reflects fourth-harmonic light 141 and transmits 147 the residual fundamental 145 and second-harmonic light 146. A second dichroic mirror 121 combines the IR and UV beams by reflecting fourth-harmonic beam 141 and transmiting the fundamental output 142 of a second laser 106. Such dielectric, dichroic mirrors are available with high damage thresholds from many vendors including CVI (Albuquerque, N. Mex.). The overlapped beams 148 are directed to a sum-frequency mixing module 112 that contains a CLBO nonlinear element. In a preferred embodiment, this CLBO crystal is cut with an azimuth angle of approximately 45° and a phase matching angle of approximately 90°. At the exit of the SFM stage, the three beams, IR, UV, and VUV are nearly overlapped 149. These beams may be separated 140 by use of a dispersive element 130 or suitable dichroic mirror.

In a preferred embodiment, bulk lithium triborate (LBO) with a phase matching angle of approximately 20 degrees is used for the first SHG module 110, that of doubling the IR fiber light 145 to the blue region of the spectrum. In another embodiment, two oppositely-oriented LBO crystals are used compensate for Poynting vector walk-off. In other embodiments, periodically-poled nonlinear optical materials are used for this first frequency-doubling interaction. Periodically-poled materials have several advantages relative to bulk media: Poynting-vector walk-off is automatically cancelled in such materials, and the single-pass efficiencies are potentially high enough to avoid the use of resonant cavities. In a preferred embodiment, poled, near-stoichiometric lithium tantalate (PPSLT) is used for second harmonic generation stage 110.

Both BBO and CLBO have sufficient transparency and birefringence for the second SHG module 111, that of doubling the blue light 146 (near 490 nm) to the ultraviolet (near 245 nm).

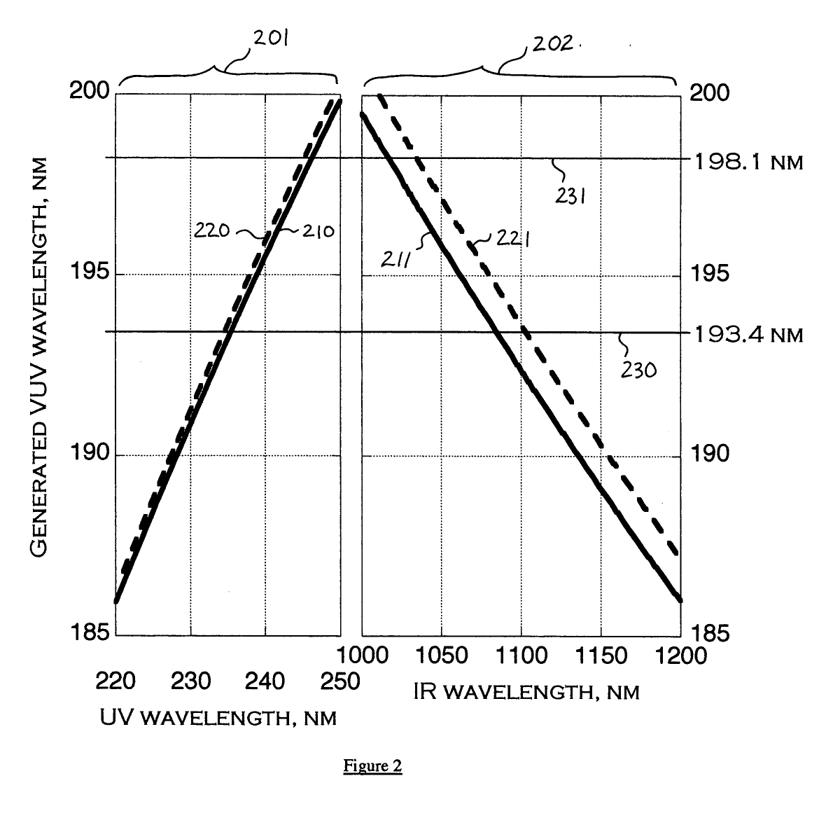

The type and nature of lasers 105, 106 are chosen with regard to the fundamental waves 145, 142. These wavelengths are ultimately set by the NCPM condition of the CLBO crystal in the final SFM module 112, and in general may not be chosen independently. FIG. 2 is a graph that shows values of interacting wavelengths that provide for non-critically phase-matched sum-frequency-mixing interactions in CLBO at two temperatures (20 and 150 degrees centigrade). Sub-200-nm light is provided from the sum-frequency-interaction of an IR wavelength 202 and a UV wavelength 201. Solid lines 210, 211 correspond to allowed interactions at 20 C, and dashed lines 220, 221 correspond to allowed interactions at 150 C. By ‘allowed interactions’ it is understood that the nonlinear sum-frequency mixing interaction is phase-matched, or nearly so, only for these pairs of wavelengths at a given temperature. Note that increasing the crystal temperature reduces the optical birefringence, so that generation of a given output wavelength requires shorter UV wavelengths, and longer IR wavelengths, than at lower temperatures. The tradeoff for reduced birefringence at higher temperatures is greatly enhanced CLBO crystal lifetimes. The data in FIG. 2 may be used to determine either or both of the interacting wavelengths given a desired final wavelength. For example, line 230 indicates the wavelength of the ArF excimer laser system (193.4 nm). The intersection of this line with the appropriate curves 210, 211, 220, 221 determines the UV and IR wavelengths required to provide a NCPM SFM interaction at a given temperature. In order to non-critically phase-match the generation of 193.4-nm light using CLBO at 150 C, one must apply a UV wavelength near 234.5 nm and an IR wavelength near 1103 nm. However, at room temperature, to generate the same final wavelength (193.4 nm), the required wavelengths are instead 235.4 nm in the UV and 1085 nm in the IR.

A number of allowed wavelength combinations for the production of different sub-200-nm VUV wavelengths at a temperature of 150 C are listed in Table 1, along with suitable rare-earth-doped fiber laser systems to produce the appropriate fundamental wavelengths. The utility of the rare-earth-doped fiber laser systems is that they may oscillate over a range of different wavelengths depending upon the design of the fiber laser system; operation at a given wavelength is generally accomplished by means of injection seeding, physical fiber design, fiber Bragg gratings, dichroic coatings, and other techniques known in the art. For example, in the second case listed below, to generate a final VUV wavelength near 198.1 m 231, a first Yb-doped fiber laser is arranged to oscillate at approximately 980 nm, and a second Yb-doped fiber laser is arranged to oscillate at approximately 1036 nm. Each of these combinations represents a preferred embodiment according to the present invention.

TABLE 1
Wavelengths and laser systems for preferred
embodiments of VUV source.

| λ_{VUV} | λ_{UV} | λ_{IR} | Laser 1 | Laser 2 |
|---|---|---|---|---|
| 193.4 nm | 234.5 nm (938 nm/4) | 1103.5 nm | Nd: fiber | Yb: fiber |
| 198.14 nm | 245.0 nm (980 nm/4) | 1036 nm | Yb: fiber | Yb: fiber |
| 190.54 nm | 228.5 nm (914 nm/4) | 1147 nm | Nd: fiber | Yb: fiber |
| 194.9 nm | 237.8 nm (951 nm/4) | 1082 nm | Nd: fiber | Yb: fiber |

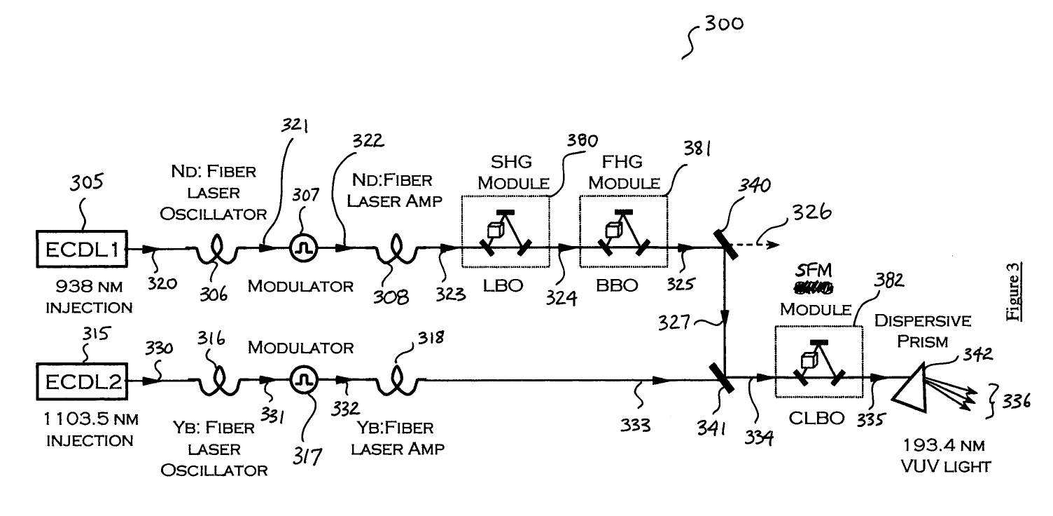

FIG. 3 illustrates a preferred embodiment of laser device 100 according to the present invention. In most embodiments, lasers 105, 106 are combinations of a number of active and passive optical elements. In one embodiment, lasers 105, 106 consist of external cavity diode lasers (ECDL) 305, 315 seeding fiber laser oscillators 306, 316. The injection seeding of oscillators 306, 316 is accomplished by techniques known in the art, and forces oscillation at single controllable wavelengths and controllable optical polarizations. ECDL assemblies are commercially available over a broad range of IR wavelengths from several manufacturers including New Focus, Inc. (Santa Clara, Calif.). In a preferred embodiment, Nd-doped fiber laser oscillator 306 is injected seeded 320 to operate near a wavelength of 938 nm, and Yb-doped fiber oscillator 316 is injection seeded 330 to operate near 1103.5 nm. Both fiber laser assemblies 306, 316, 308, 318 incorporate polarization-maintaining (PM) fiber or other means known in the art to prevent de-polarization of the IR light. In some embodiments, light from oscillators 306, 316 are directed to optical modulators 307, 317. These modulators are commercially available from vendors such as New Focus (Santa Clara, Calif.) and change either the optical phase or amplitude of IR light 321, 331 in response to an externally-applied electrical signal (not shown). In a cw embodiment of light source 300, modulators 307, 317 vary the optical phase of low-power IR laser light 321, 331 to facilitate the process of locking of resonant optical cavities 380, 381, 382. In a pulsed embodiment of light source 300, modulators 307, 317 vary the amplitude of low-power IR laser light 321, 331 to set the pulsewidths and duty cycle. Fiber laser amplifiers 308, 318 provide for power amplification of modulated light 322, 332. Optical isolators and other standard equipment known in the art to be beneficial for optical coupling between fibers are not shown. Depending upon the desired optical power levels, amplified light 323, 333 may be further amplified using additional fiber amplifiers. Fiber amplifier components are available from vendors including Nufern and IPG Photonics (Oxford, Mass.).

High-power IR light 323 is directed to a first SHG module 380. Module 380 is disposed to frequency-double the IR beam 323 in a solid-state crystal using standard critical or non-critical phase matching techniques. In one embodiment, SHG module 380 contains the nonlinear crystal LBO cut for a phase matching angle of approximately 20 degrees. In another embodiment, SHG module 380 contains a periodically-poled stoichiometric lithium tantalate (PPSLT) crystal. Both crystals are available from several sources, including Oxide. Second-harmonic light 324 is subsequently directed to a second SHG module 381. Module 381 is disposed to frequency-double the visible beam 324 in a solid-state crystal using standard critical or non-critical phase matching techniques. In a preferred embodiment, SHG module 381 contains the nonlinear crystal BBO cut for a phase matching angle of approximately 58.4 degrees. Lenses and other standard optics for relaying, beam-shaping, and mode-matching the applied beams 323, 324 are not shown, as specific values depend upon available power levels and crystal parameters.

At the exit of the second SHG stage 381 there are several wavelengths 325. Dielectric dichroic mirror 340 transmits the long-wavelength beams 326 and reflects the desired UV fourth-harmonic beam 327. UV beam 327 is overlapped with the fundamental IR beam from the second laser system 333 by dichroic mirror 341. The overlapped IR and UV beams 334 are directed to SFM module 382 that contains the nonlinear crystal CLBO. In a preferred embodiment, the CLBO crystal is maintained at an elevated temperature near 150 degrees centigrade by placing the crystal in an oven (not shown). Ovens and temperature controllers are available from EKSPLA (Vilnius, Lithuania). In a preferred embodiment, the CLBO nonlinear crystal is cut with a phase matching angle near 90 degrees, in order to facilitate NCPM of the UV and IR beams 333, 327.

In a cw embodiment of light source 300, SHG modules 380, 381, and SFM module 382 may incorporate resonant optical cavities. These cavities are phase-locked to optical light 323, 324, 334 respectively by standard techniques to increase the circulating intensity of the interacting waves and hence the nonlinearity available for VUV frequency conversion. Two methods known in the art to phase-lock optical cavities to an applied laser field are the Hansch-Couillard and Pound-Drever-Hall techniques. In one cw embodiment, modules 380, 381 contain ring-geometry resonant cavities (as shown schematically in FIG. 3). In another cw embodiment, modules 380, 381 contain bow-tie-geometry resonant cavities. Bow-tie cavities are useful to correct for the astigmatism that is produced when the modules' nonlinear crystals are cut at Brewster angle. Resonant cavities typically contain a movable optical element, for example a mirror mounted on a piezo-electric transducer, by means of which the optical cavity length may be continuously adjusted to maintain a resonance condition. Modules 380, 381 are known as singly-resonant cavities in that they maintain resonance with a single optical field 323, 324. Module 382 may be a singly-resonant cavity or a doubly-resonant cavity. To maintain double resonance, the cavity length is slaved to follow fluctuations in the wavelength of one of the applied fields 333, 327 and the wavelength of the other applied field is slaved to follow fluctuations in the cavity length. The wavelength of the fiber laser assemblies 306, 308, 316, 318 may be controlled by adjusting the seeding wavelengths 305, 315, 320, 330 by standard techniques.

The multitude of beams 335 at the exit of the SFG module 382 may be dispersed 336 by suitable optics 342 to provide the VUV wavelength. One possibility is a dispersive prism, as shown, although dielectric mirrors could also be employed. In some embodiments, the optics comprising the SFG module 382 and dispersion optics 342 are enclosed and the atmosphere purged or evacuated to reduce absorption of the final short-wavelength light.

From this basic description, a number of different methods and architectures may immediately be envisioned and applied by those skilled in the art to the generation of VUV light using fiber laser assemblies and non-critically phase-matched sum-frequency mixing interactions in the nonlinear crystal CLBO. Accordingly, the scope of the invention should be determined by the following claims and their legal equivalents.

1. An architecture for the generation of coherent, sub-200-nm coherent laser radiation, comprising:
A first fiber laser assembly providing a first IR wavelength;
A second fiber laser assembly providing a second IR wavelength;
A first second-harmonic generation module disposed to frequency-double said first IR wavelength to produce a third visible wavelength;
A second second-harmonic generation module disposed to frequency-double said third wavelength to produce a fourth ultraviolet wavelength;
A sum-frequency mixing module disposed to frequency-mix said second IR and said fourth ultraviolet wavelengths to produce a fifth ultraviolet wavelength;
Wherein said sum-frequency module contains the nonlinear crystal cesium-lithium-borate;
Wherein said fifth ultraviolet wavelength is less than 200 nm; and
Wherein the particular choices of said second ir wavelength, and said fourth ultraviolet wavelength approximately fufill a non-critical phase-matching condition for a sum-frequency mixing interaction within said CLBO nonlinear optical crystal.

2. The architecture of claim 1 wherein said CLBO nonlinear crystal is heated to a temperature between 140 and 160 degrees centigrade.

3. The architecture of claim 1 wherein said first fiber laser system contains an active neodymium-doped fiber laser and said second fiber laser system contains an active ytterbium-doped fiber laser.

4. The architecture of claim 1 wherein said first IR wavelength is between 930 nm and 952 nm and said second IR wavelength is between 1070 nm and 1110 nm.

5. The architecture of claim 1 wherein said first IR wavelength is between 905 nm and 915 nm and said second IR wavelength is between 1130 nm and 1200 nm.

6. The architecture of claim 1 wherein said first IR wavelength is between 975 nm and 985 nm and said second IR wavelength is between 1020 nm and 1045 nm.

7. An architecture for the generation of coherent, sub-200-nm coherent laser radiation, comprising:
A neodymium-doped fiber laser assembly providing a first IR wavelength in the range of 900 nm to 1000 nm;
A ytterbium-doped fiber laser assembly providing a second IR wavelength in the range of 1000 nm and 1200 nm;
A first second-harmonic generation module disposed to frequency-double said first IR wavelength to a third visible wavelength;
A second second-harmonic generation module disposed to frequency-double said third wavelength to a fourth ultraviolet wavelength;
A sum-frequency mixing module disposed to frequency-mix said second IR and said fourth ultraviolet wavelengths to produce a fifth ultraviolet wavelength;
Wherein said sum-frequency module contains the nonlinear crystal cesium-lithium-borate maintained at a temperature between 140 Celcius and 160 degrees centigrade;
Wherein said fifth ultraviolet wavelength is less than 200 nm; and
Wherein the particular choices of said second IR wavelength, and said fourth ultraviolet wavelength approximately fufill a non-critical phase-matching condition for a sum-frequency mixing interaction within said CLBO nonlinear optical crystal.
